(19) United States
(12) Patent Application Publication
(10) Pub. No.: US 2014/0025357 A1
(43) Pub. Date: Jan. 23, 2014

(54) METHOD OF PREDICTING THE RESPONSE OF AN INDUCTION LOGGING TOOL

(71) Applicants: Steen Agerlin Petersen, Bergen (NO); Petrus Maria Van Den Berg, The Hague (NL); Jacob Tjeerd Fokkema, Schiedam (NL)

(72) Inventors: Steen Agerlin Petersen, Bergen (NO); Petrus Maria Van Den Berg, The Hague (NL); Jacob Tjeerd Fokkema, Schiedam (NL)

(73) Assignee: STATOIL PETROLEUM AS, Stavanger (NO)

(21) Appl. No.: 13/982,211

(22) PCT Filed: Feb. 2, 2011
(86) PCT No.: PCT/EP11/51495

§ 371 Date: Oct. 9, 2013

(51) Int. Cl. G01V 3/28

(52) U.S. Cl. CPC G01V 3/28
USPC 703/2

(57) ABSTRACT

There is provided a method of predicting the response of an induction logging tool along an arbitrary trajectory in a three-dimensional earth model, wherein the method comprises a confinement of the electromagnetic field computations to a limited domain of the geology surrounding the induction logging tool. The magnetic field at a receiver coil is considered as a superposition of a primary background constituent and a secondary constituent. A single spherical scatterer approximation is used for the second constituent.

The invention relates to methods for predicting the response of an induction logging tool along an arbitrary trajectory in a three-dimensional earth model.

### BACKGROUND OF INVENTION

It is known to produce an induction log which is a log of the conductivity of rock with depth obtained by lowering into a borehole a generating coil that induces eddy currents in the rocks and these are detected by a receiver coil. In the simplest device, an alternating current of medium frequency (100 kHz up to a few MHz) is generated in a source coil, thereby inducing an alternating magnetic field in the formation. This magnetic field creates electric currents in the formation. The electric currents generate their own magnetic fields, which induce again an electric current in the receiver coil. The signal received depends on the electric conductivity of the surrounding earth formation, with contributions from different regions of the formation. An effective computational model is required that describes the major physical properties of the electromagnetic field behaviour around the logging tool, particularly in cases where the computational burden of real-time computations is too large.

In the oil-industry, induction logging is a relevant method to discriminate between hydro-carbon-bearing and water (or shale)-bearing zones in the subsurface. The physical principle underlying the method is to probe the differences in electrical conductivity between the different zones by applying an electromagnetic field. When an induction tool is lowered in a borehole, the electromagnetic field of the (time-harmonic) magnetic dipole source(s) in the tool induces electrical currents in the formation. These induced currents contribute to the measured response in the magnetic dipole receiver(s) which are also located in the tool some distance apart of the magnetic dipole source(s). The interpretation of the measured response in terms of the formation conductivity then gives in principle an indication for the location of the hydrocarbon bearing zones. The conventional logging tool consists of axially symmetrical source and receiver coils, resulting in axial symmetrical sensitivity. In order to observe anisotropic properties of the formation conductivity, modern directional sensitive logging tools are used with tilted-receiver-coil arrangements. Theoretical principles of the induction-logging method in some relatively simple canonical configurations can be found in the book by A. A. Kaufman and Yu. A. Dashevsky, 2003, Principles of induction logging, Methods in Geochemistry and Geophysics, vol. 38, Elsevier, Boston.

### SUMMARY OF INVENTION

The invention provides a method for predicting the response of an induction logging tool, as set out in the accompanying claims.

The present invention relates to a method for predictive computation of the response of an induction logging tool for the purpose of the analysis or synthesis of realistic earth models. The method aims to predict in a reliable and computational fast way the response of a logging tool along an arbitrarily prescribed borehole trajectory in a full 3D earth model, such that different realizations of both borehole trajectories and earth models can be evaluated effectively. From a physical point of view, a logging tool consists of a magnetic source-dipole (source coil) located at the tool axis in a direction perpendicular to the tool axis and a magnetic receiver-dipole (receiver coil) located at the tool axis in an arbitrary direction. The computation of the response of a logging tool in a full 3D inhomogeneous and anisotropic medium requires a full 3D code based on Maxwell equations. Although these codes, e.g. integral equation methods, finite element methods and finite difference methods, are nowadays available or becoming available, the computational burden is too large to carry out ‘real-time’ computations for different realizations of borehole trajectory and realistic earth model. Hence, an effective approximate model that includes all the necessary physics is required. The configurations for investigation are obtained from a representative compound model according to the Statoil data base (S. A. Petersen, 2004, Optimization Strategy for Shared Earth Modeling, EAGE Conference, Paris, 7-10 June, 2004).

The invention can provide a method for real-time predictive computation of a logging response in a full 3D earth model. The method can be real-time in the sense that it can be performed contemporaneously with the taking of real-time measurements in the borehole. The logging response is the response of a tool, producing a so-called well log of the geologic formations penetrated by a borehole. This log encompasses measurements along a trajectory through a 3D anisotropic medium, for some prescribed electromagnetic frequency of operation. The method allows for the definition of an arbitrarily curved logging trajectory (i.e. the trajectory followed by a logging tool), along which the electromagnetic response is computed.

The borehole trajectory can be replaced by locally straight line segments. Along each line segment, the electromagnetic field is only significant within a 3D volumetric window of limited dimensions (reduced moving window in a 3D space). During the computation the window can move and turn as it follows the trajectory. The size of this reduced window of observation depends both on the frequency of operation of the induction logging tool and the local electrical conductivity of the earth formation around the tool.

The influence of limiting the observational domain of the reduced window can be checked by computing and plotting in this window the sensitivity distribution of the electromagnetic response.

In each reduced window, a background medium may be chosen to be homogeneous and isotropic, where the electromagnetic field is described by a simple analytic expression. One way to obtain the pertaining conductivity background is to average the conductivity around the tool domain.

A preferred method for induction logging includes a data-driven determination of the local effective (homogeneous and isotropic) background medium from the measurements at two closely located axial receiver coils, where the axial component of the magnetic field is generated by an axial source coil. Another preferred method includes two measurements at one axial receiver coil, where two electromagnetic fields are generated by two closely located source coils. In both cases, calibration of the measurements is superfluous.

In each local window with a matched homogeneous and isotropic background medium, the primary electromagnetic field may be obtained directly from a simple closed-form expression. Subsequently, the electric currents due to the isotropic and/or anisotropic differences in the electrical conductivity with respect to the effective one of the background medium in the window under investigation, are seen as contrast currents that generate a secondary field.

In view of the reduced size of each local window and the relative small changes of the contrast in electrical conductivity with respect to the one of the matched homogeneous and isotropic background, the interaction between different regions within the local window can be neglected and each contrasting region may be seen as a single spherical disturbance (scatterer). The known and so-called Single-Spherical-Scatterer approximation (see E. Slob, 1994, Scattering of Transient Diffusive Fields, Ph.D. Thesis, Delft University of Technology, Delft University Press, The Netherlands, page 50) is used advantageously to provide a simple and effective model for the actual disturbance of the electromagnetic field by the contrasting conductivity in the reduced window. The dominant physical phenomena are included in the present approximations.

Embodiments of the invention will now be described, by way of example only with reference to the accompanying drawings.

### BRIEF DESCRIPTION OF THE DRAWINGS

FIG. 1 shows a model of a dipping anisotropic conductivity layer in the vertical (x₁, x₃)-plane.

FIG. 2 shows a curved borehole trajectory in the vertical plane.

FIG. 3 shows the locally straight line segment of the local borehole trajectory in the vertical plane.

FIG. 4 shows the reduced observational window along the locally straight line segment of the local borehole trajectory.

FIG. 5 shows along the local borehole segment, the domain around the logging tool to be used for averaging the conductivity.

FIG. 6 shows the directions of the local borehole axis and the principal conductivity axis.

FIG. 7 shows the logging coordinates in a local coordinate system.

FIG. 8 shows the rotation of a tilted receiver dipole.

### DETAILED DESCRIPTION

1. Cartesian Coordinates and Description of Anisotropy

For purpose of mathematical description, let the spatial position in a Cartesian coordinate frame be given by the vector \vec{x}={x₁,x₂,x₃}. Further, an electromagnetic time-dependence exp(−iωt) is assumed, where i²=−1, ω=angular frequency and t=time.

A medium with anisotropic electrical conductivity is standard described by a matrix. The conductivity matrix in a point \vec{x}depends on the local medium gradients. For simplicity a 2D medium is considered that is invariant in the x₂-direction. Let, for a dipping local layer with biaxial anisotropic conductivity, the three so-called principal axes be denoted by σ₁, σ₂ and σ₃. The principal axes are the conductivities along a rotated local Cartesian reference in this dipping layer (see FIG. 1). Let the medium gradient be given by the vector {g₁,0,g₃}, where gₜ=cos(β) and g₃=sin(β). Here, β denotes the angle of dipping of the local layer (see FIG. 1). At each point of observation \vec{x}, the conductivity of the anisotropic medium is characterized by the tensor σ as given by

$$σ = R ( \begin{matrix}{σ}_{1} & 0 & 0 \\ 0 & {σ}_{2} & 0 \\ 0 & 0 & {σ}_{3}\end{matrix} ) {R}^{T} = ( \begin{matrix}{σ}_{1} {g}_{1}^{2} + {σ}_{3} {g}_{3}^{2} & 0 & ( {σ}_{3} - {σ}_{1} ) {g}_{1} {g}_{3} \\ 0 & {σ}_{2} & 0 \\ ( {σ}_{3} - {σ}_{1} ) {g}_{1} {g}_{3} & 0 & {σ}_{1} {g}_{3}^{2} + {σ}_{3} {g}_{1}^{2}\end{matrix} ) \qquad ( 1 )$$

The medium gradients {g₁,0,g₃} are related to the dipping layers (which are layers in the geological formation which are dipped relative to horizontal) through the rotation matrix R:

$$R = ( \begin{matrix}{g}_{1} & 0 & {g}_{3} \\ 0 & 1 & 0 \\ - {g}_{3} & 0 & {g}_{1}\end{matrix} ) = ( \begin{matrix}cos ( β ) & 0 & sin ( β ) \\ 0 & 1 & 0 \\ - sin ( β ) & 0 & cos ( β )\end{matrix} ) \qquad ( 2 )$$

in which β (see FIG. 1) is the global angle to rotate the direction of the local dipping of the medium quantities relative to the horizontal xₗ-axis. Note that the matrix R^{T} in Equation (1) denotes the transpose of R.

2. Curved Borehole Trajectory and Rotated Local Cartesian Coordinates

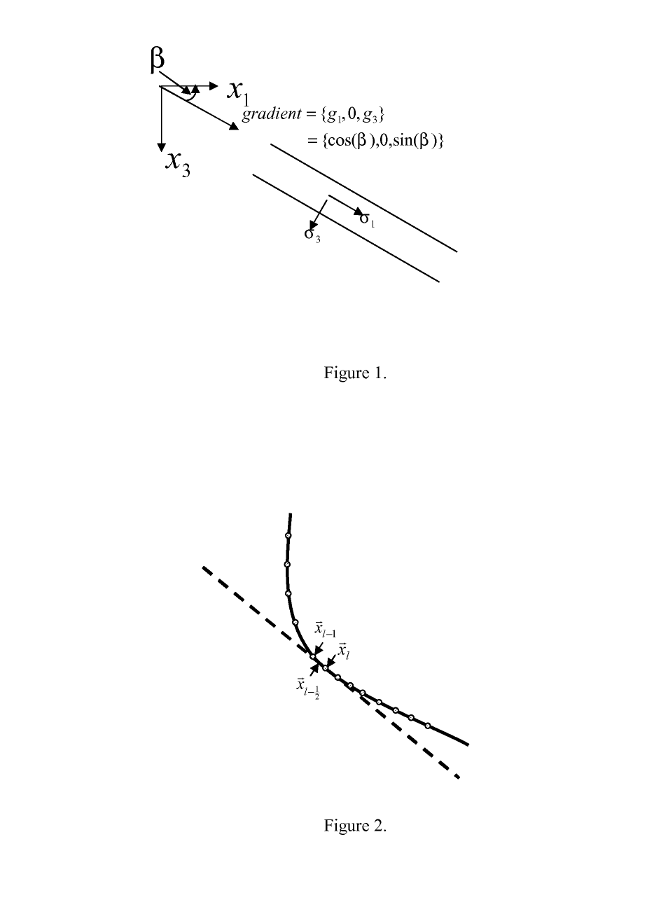

We assume that the trajectory of the curved borehole is described accurately enough by a number of discrete points \vec{x}ₗ={x_{l,1},x_{l,2},x_{l,3}}. The subscript l denotes the number of the logging position, which represents the position of the tool as shown in FIG. 2. Between two neighboring points it is assumed that the borehole trajectory is locally a straight line.

We further assume that the electromagnetic induction logging measurement with ordinal number l is carried out when the center of the logging tool is at the midpoint \vec{x}_{l-1/2} of a line segment between two discrete points \vec{x}ₗ and \vec{x}ₗ₋₁. For the computation of the electromagnetic induction logging response at the midpoint, of each line segment, we replace the curved borehole trajectory by one with a straight borehole axis coinciding with the local straight line segment of the curved borehole trajectory. It is observed that, if this latter straight borehole axis coincides with one of the axes of the Cartesian coordinate system, the computation of the logging response is carried out in the simplest way.

In this method the Cartesian coordinate system is rotated in such a way that the locally straight borehole axis coincides with the axis of a local coordinate system with center at the logging position half a way between two discrete points of the borehole trajectory. In general this coordinate rotation is carried out in two steps.

The first step is a rotation over the angle between the projection on the horizontal plane of the local borehole axis and the horizontal x₁-axis. Each straight line segment of the borehole trajectory is then located in the vertical plane with x₂′=0 of a new Cartesian system with coordinates \vec{x}′={x₁′,x₂′,x₃′}. When the borehole trajectory is already located in the vertical plane, with x₂=0, this rotation step is superfluous. For simplicity of the analysis, it is assumed that the borehole trajectory is completely located in the vertical plane with x₂=0. Then the local coordinate system is defined as

x₁′=x₁−x_{l-1/2,1}

x′₂=x₂

x₃′=x₃−x_{l-1/2,3} (3)

where {x_{l-1/2,1},0,x_{l*1/2,3}}={½(x_{l-1,1}+x_{l,1}),0,½(x_{l-1,3+x}_{l,3})} is the midpoint of two adjacent point of the borehole trajectory under consideration.

The second step is to rotate the local coordinate system over the angle φ between the local borehole axis and the vertical x₃-axis (see FIG. 3). After rotation over the angle φ the new local Cartesian coordinate \vec{x}″={x₁″,x₂″,x₃″} is obtained from the previous one as

x₁″=x₁′ cos(φ)−x₃′ sin(φ)

x₂″=x₂′

x₃″=x₁′ sin(φ)+x₃′ cos(φ) (4)

3. Moving Reduced Window Along Borehole Trajectory

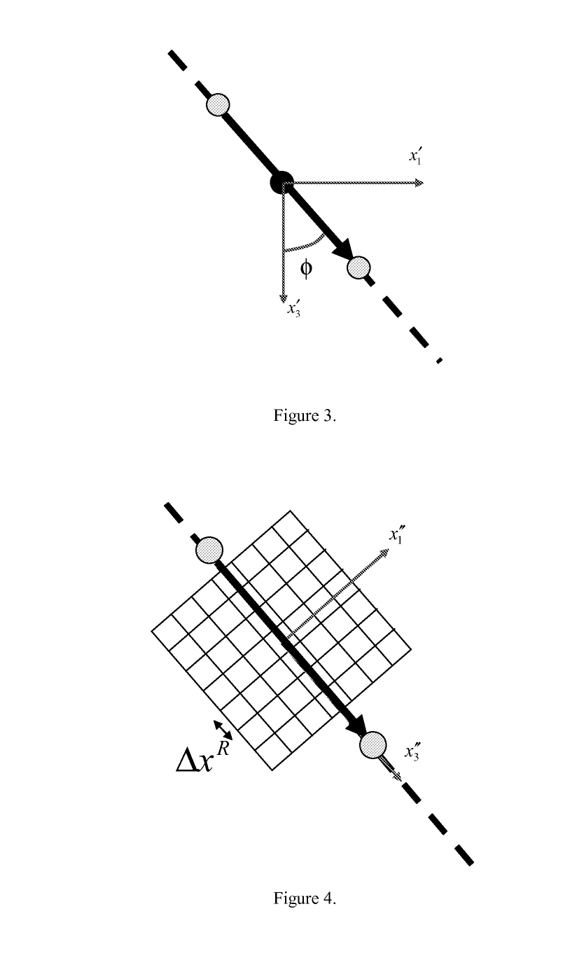

In the present method it is observed that in the earth formation where the electromagnetic field, operating at medium frequencies, penetrates in the geology in a very limited domain around the logging tool. As a consequence in the method described here the computational domain is restricted to a limited rectangular 3D domain D around the logging point at the midpoint of a straight line segment (see FIG. 4, in which the domain D is shown as a two-dimensional grid). While moving the logging tool along the borehole trajectory and considering only a limited domain of observation, it is observed that the logging tool operates within a moving reduced 3D window D along the discretized trajectory segments. For numerical convenience this reduced window D is discretized with a cell size of Δx^{R} in the three local coordinate directions. The centers of the subdomains (i.e. cells) are given by

x_{1,i}″=iΔx^{R},i=−N₁^{R}, . . . ,N₁^{R}

x_{2,i}″=jΔx^{R},j=−N₂^{R}, . . . ,N₂^{R}

x_{3,i}″=kΔx^{R},k=−N₃^{R}, . . . ,N₃^{R} (5)

The indices i, j and k denote the positions of the cell centers, while N₁^{R}, N₂^{R} and N₃^{R} are the number of cells in the x₁″, x₂″ and x₃″-directions, respectively. The dimensions of the window is (2N₁^{R}+1)Δx^{R}×(2N₂^{R}+1)Δx^{R}×(2N₃^{R}+1)Δx^{R}. The choice of the cell size and the dimensions of the window, i.e. Δx^{R} and {N₁^{R},N₂^{R},N₃^{R}}, are dictated by the frequency of operation and local conductivity via the skin (penetration) depth of the medium in the reduced window. In each cell of the reduced window the principal values of the conductivity tensor and the medium gradient is obtained from the global principal values of the conductivity tensor and the global medium gradients of the compound grid by a bivariate interpolation using a four point formula (M. Abramowitz and I. A. Stegun, 1965, Handbook of Mathematical Functions, Dover Publications, New York., p. 882). In each reduced window, the interpolated values of the principal axes {σ₁,σ₂,σ₃} are denoted as {\tilde{σ}₁,\tilde{σ}₂,\tilde{σ}₃}. Similarly, the interpolated value of the previous introduced dipping angle β is denoted as \tilde{β}.

4. A Homogeneous and Isotropic Background Medium in Local Window

Before discussing the calculation of the logging tool response, the method described here deals with a background medium, where primary calculations of the electromagnetic field are carried out. Although it is free to choose any background in our local window, a homogeneous and isotropic background medium in which the electromagnetic field can be computed easily and in which this background is as closest as possible to the actual one should be preferred. This preference of the background means that the differences of the actual conductivity tensor and the constant background value, denoted as the contrasting conductivity tensor in the local window of investigation, are limited. This enables further approximations.

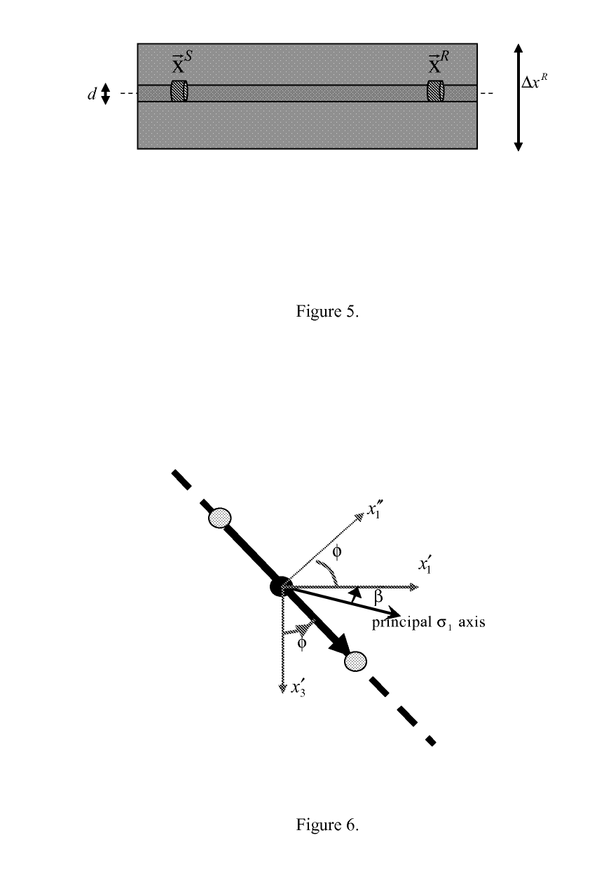

One embodiment is the choice of an appropriate homogeneous and isotropic background. Therefore, the domain located very close to the logging tool is considered in more detail. This domain consists of the borehole and the formation in direct contact with the logging tool. In fact, it is the domain where the electromagnetic field is highly concentrated. The aim is to obtain an average isotropic value of the conductivity in this latter domain. In most cases the borehole diameter d is less or equal than the chosen mesh size Δx^{R} of the discretized reduced window (see FIG. 5). The (isotropic) conductivity of the medium in the borehole is denoted by σ^{b}. Defining x^{SR} as the distance between the centers of the source and receiver locations, a 3D rectangular domain located around the logging tool with cross-sectional dimension Δx^{R}×Δx^{R} and length x^{SR} is considered, the so-called logging-tool domain. In this logging-tool domain a homogenous and isotropic medium is thought to be present with isotropic conductivity \tilde{σ}=⅓[\tilde{σ}₁+\tilde{σ}₂+\tilde{σ}₃], where {\tilde{σ}₁,\tilde{σ}₂,\tilde{σ}₃} are the principal axes of the interpolated values of the anisotropic conductivity of the medium actually present around the borehole. In the present method these considerations are taken into account by defining the average isotropic conductivity of the logging-tool domain as

$${\tilde{σ}}_{0} = \frac{1}{2 floor ( {x}^{SR} / 2 Δ {x}^{R} ) + 3} {\sum }_{k = - floor ( {x}^{SR} / 2 Δ {x}^{R} ) + 1}^{k = floor ( {x}^{SR} / 2 Δ {x}^{R} ) + 1} \tilde{σ} ( k Δ {x}^{R} ) + \frac{1}{4} {π ( \frac{d}{Δ {x}^{R}} )}^{2} [ {σ}^{b} - \tilde{σ} ( k Δ {x}^{R} ) ] \qquad ( 6 )$$

Here, the floor(.) denotes the function that rounds its argument to the nearest integer less than or equal to its argument. In the method described here, this quantity is taken as the homogenous background in our reduced window. The difference of the actual conductivity tensor and this background value is defined as the contrasting conductivity tensor.

5. Data Driven Computation of the Effective Background Conductivity in Local Window

In another embodiment of the method, the constant conductivity of a homogenous and isotropic background medium in the reduced window is determined from the measured data.

Consider the following analysis.

Assume that the measured electromagnetic field is generated by an axial source coil and the axial magnetic field is measured by a receiver coil, and that the major contribution of this measured field component is determined by an electromagnetic field propagating from source to receiver in a properly chosen homogeneous and isotropic background. Then this measured field component is described as

$${H}_{3}^{( 1 )} = {M}^{s} ( \frac{2}{{( {x}^{SR} )}^{2}} + \frac{2 {\tilde{γ}}_{0}}{{x}^{SR}} ) \frac{exp ( - {\tilde{γ}}_{0} {x}^{SR} )}{4 π {x}^{SR}} , \\ {\tilde{γ}}_{0} = {( - i ω {μ}_{0} {\tilde{σ}}_{0} )}^{\frac{1}{2}} \qquad ( 7 )$$

where M^{S} is the magnetic dipole moment of the source coil and where x^{SR} is the distance between source and receiver coil. In the method described here it is further assumed that a second axial receiver coil is present at a small distance Δx^{SR} apart from the first receiver. Then this second receiver measures a field

$${H}_{3}^{( 2 )} = {M}^{s} ( \frac{2}{{( {x}^{SR} + Δ {x}^{SR} )}^{2}} + \frac{2 {\tilde{γ}}_{0}}{{x}^{SR} + Δ {x}^{SR}} ) \frac{exp ( - {\tilde{γ}}_{0} {x}^{SR} - {\tilde{γ}}_{0} Δ {x}^{SR} )}{4 π ( {x}^{SR} + Δ {x}^{SR} )} \qquad ( 8 )$$

Taking the logarithm of the quotient of the two expressions and some reordering yields

$$ln [ \frac{{H}_{3}^{( 1 )}}{{H}_{3}^{( 2 )}} ] + 3 ln [ \frac{{x}^{SR}}{{x}^{SR} + Δ {x}^{SR}} ] = - ln [ 1 + \frac{{\tilde{γ}}_{0} Δ {x}^{SR}}{1 + {\tilde{γ}}_{0} {x}^{SR}} ] + {\tilde{γ}}_{0} Δ {x}^{SR} \qquad ( 9 )$$

Note that in the quotient of H₃⁽¹⁾ and H₃⁽²⁾ the magnetic dipole moment M^{S} has been eliminated. Hence, calibration of the data is superfluous.

As next step it is assumed that the two receiver coils are closely located to each other, so that the logarithmic function on the right-hand side of Equation (9) is approximated by the formula ln(1+x)≈x−½x²+⅓x³. Then a cubic equation for the unknown \tilde{γ}₀ is obtained as

\tilde{γ}₀³[Δx^{SR}(x^{SR})²]+\tilde{γ}₀²[Δx^{SR}x^{SR}+½(Δx^{SR})²−(x^{SR})²A]−\tilde{γ}₀[2x^{SR}A]−A=0 (10)

where A is equal to the left-hand side of Equation (9), viz.

$$A = ln [ \frac{{H}^{( 1 )}}{{H}^{( 2 )}} ] + 3 ln [ \frac{{x}^{SR}}{{x}^{SR} + Δ {x}^{SR}} ] \qquad ( 11 )$$

The proper solution \tilde{γ}₀ of the cubic equation yields the effective conductivity in the local window as

\tilde{σ}₀=(−iωμ)⁻¹\tilde{γ}₀² (12)

Note that this effective conductivity defines a homogeneous and isotropic background medium, in which an electromagnetic field is generated that approximates as close as possible the ratio of the actual responses measured by the two closely related receivers.

Note further, that in view of reciprocity, we can interchange source and receiver locations. This means that in another embodiment of the method, the effective conductivity of the homogeneous and isotropic background is arrived at by two measurements at one axial receiver coil, where two electromagnetic fields are generated by two closely located source coils. Also in this setup, calibration of the measurements is superfluous.

6. Rigorous Field Formulation

Before explaining the approximations made in the methods described here we start with an exact mathematical formulation to compute the magnetic field responses of the logging tool. Since the magnetic field response of a logging tool in a homogeneous and isotropic medium can be calculated in a very simple way, the measured magnetic field at the receiver coil \vec{x}″=\vec{x}^{R}, is written as the superposition of a primary constituent and a secondary constituent

H(\vec{x}^{R})=H^{prm}(\vec{x}^{R})+H^{scd}(\vec{x}^{R}) (13)

where the primary magnetic field is the field response of the logging tool in a homogeneous and isotropic medium with conductivity \tilde{σ}₀. Note that this background conductivity varies along the borehole trajectory, in accordance with either the average of the known conductivity distribution of Equation (6) or the data-driven value of Equation (12). Operating in this way the local homogeneous background has been as close as possible to the actual medium in the tool domain, so that the actual electric currents flowing in the formation do not differ substantially from the currents in the background medium.

The mathematical expression for the primary field from a magnetic dipole in a homogeneous background is well-known in the literature. The secondary field due to contrast distribution is not in a closed-form expression. It is known (see G. W. Hohmann, 1975, Three-dimensional induced polarisation and electromagnetic modeling, Geophysics, vol. 40, pp. 309-324.) that it can be written as the superposition of responses of individual contrast currents (χE), in the window D:

$${H}^{scd} ( {{x}^{->}}^{R} ) = {\tilde{σ}}_{0} {∇}^{R} \times {\int }_{{{x}^{->}}^{″} ∈ D} G ( {{x}^{->}}^{R} - {{x}^{->}}^{″} ) X ( {{x}^{->}}^{″} ) E ( {{x}^{->}}^{″} ) d V \qquad ( 14 )$$

where ∇^{R}={∂/∂x₁^{R},∂/∂x₂^{R},∂/∂x₃^{R}} and G is the Green function of the isotropic and homogeneous background with conductivity \tilde{σ}₀. This Green function is given by

$$G ( {{x}^{->}}^{R} - {{x}^{->}}^{″} ) = \frac{exp ( - {\tilde{γ}}_{0} \vert ( {{x}^{->}}^{R} - {{x}^{->}}^{″} ) \vert )}{4 π \vert ( {{x}^{->}}^{R} - {{x}^{->}}^{″} ) \vert} \qquad ( 15 )$$

The anisotropic conductivity contrast function x is given by

ω(\vec{x}″)=σ(\vec{x}″)/\tilde{σ}₀−I (16)

in which

$$σ ( {{x}^{->}}^{″} ) = ( \begin{matrix}{σ}_{11} ( {{x}^{->}}^{″} ) & {σ}_{12} ( {{x}^{->}}^{″} ) & {σ}_{13} ( {{x}^{->}}^{″} ) \\ {σ}_{21} ( {{x}^{->}}^{″} ) & {σ}_{22} ( {{x}^{->}}^{″} ) & {σ}_{23} ( {{x}^{->}}^{″} ) \\ {σ}_{31} ( {{x}^{->}}^{″} ) & {σ}_{32} ( {{x}^{->}}^{″} ) & {σ}_{33} ( {{x}^{->}}^{″} )\end{matrix} ) , \\ I = ( \begin{matrix}1 & 0 & 0 \\ 0 & 1 & 0 \\ 0 & 0 & 1\end{matrix} ) \qquad ( 17 )$$

The integration in the right-hand side of Equation (14) is taken over the domain D of the reduced window. This is the domain where the integrand has non-negligible contributions.

Note that the secondary field depends non-linearly on the contrast in the domain of the reduced window, since the electric field E in the domain D depends on the contrast as well. However, the electric field E in the window domain D cannot be simply determined and follows from a solution of an integral equation over D, (see Hohmann [1988])

$$E ( {{x}^{->}}^{″} ) = {E}^{prm} ( {{x}^{->}}^{″} ) + ( {ω}^{2} {μ}_{0} {σ}_{0} + {∇}^{″} {∇}^{″} • ) {\int }_{{y }^{″} ∈ D} G ( {{x}^{->}}^{″} - {{y}^{->}}^{″} ) X ( {{y}^{->}}^{″} ) E ( {{y}^{->}}^{″} ) d V \qquad ( 18 )$$

where ∇″={∂/∂x₁″,∂/∂x₂″,∂/∂x₃″}. After proper discretization, a numerical solution of this integral equation requires inversion of a system of linear equations, from which the electric field in each grid point is obtained. With, for instance a discretization of the window domain D into 30 by 30 by 30 sub cubes, the numerical procedure requires the solution of a system of 81.000 equations. For a logging response along a borehole trajectory with many logging positions, these numerical computations cannot be carried out in real time.

7. Single Spherical Scatterer Approximation

In the method, it is anticipated that the matched choice of the background of each local window limits the amplitudes of the contrast function χ over the window of investigation and some appropriate approximation would be very effective.

In view of the reduced size of each local window and the relative small changes of the contrast in electrical conductivity with respect to the one of the matched homogeneous and isotropic background, a further aspect of the method is that the interaction between different regions within the local window can be neglected and each contrasting region may be seen as a single spherical disturbance (scatterer). In mathematical terms, it is equivalent with the observation that the main contribution of the integral in Equation (18) comes from the singular contribution at \vec{y}″=\vec{x}″. For each point \vec{x}″, it is assumed that the main contribution comes from a vanishing sphere with center at \vec{x}″. For a vanishing sphere around this point we have the relations (see Slob [1994], p. 50)

$${\int }_{{{y}^{->}}^{″} ∈ sphere} G ( {{x}^{->}}^{″} - {{y}^{->}}^{″} ) X ( {{y}^{->}}^{″} ) E ( {{y}^{->}}^{″} ) d V = 0$$

$$and$$

$${∇}^{″} {∇}^{″} • {\int }_{{{y}^{->}}^{″} ∈ sphere} G ( {{x}^{->}}^{″} - {{y}^{->}}^{″} ) X ( {{y}^{->}}^{″} ) E ( {{y}^{->}}^{″} ) d V = - \frac{1}{3} X ( {{x}^{->}}^{″} ) E ( {{x}^{->}}^{″} )$$

so that the integral equation becomes algebraic, viz.,

E(\vec{x}″)=E^{prm}(\vec{x}″)+⅓χ(\vec{x}″)E(\vec{x}″), for all \vec{x}″εD. (19)

Its solution is simply obtained as

E(\vec{x}″)=[I+⅓χ(\vec{x}″)]⁻¹E^{prm}(\vec{x}″) (20)

Substituting this approximation of Equation (20) into the field representation of Equation (14) for the scattered field at the receiver coil, the secondary field response is obtained as

$${H}^{scd} ( {{x}^{->}}^{R} ) = {\tilde{σ}}_{0} {∇}^{R} \times {\int }_{{x}^{″} ∈ D} G ( {{x}^{->}}^{R} - {{x}^{->}}^{″} ) C ( {{x}^{->}}^{″} ) {E}^{prm} ( {{x}^{->}}^{″} ) d V \qquad ( 21 )$$

where the C matrix is given by

C(\vec{x}″)=[χ(\vec{x}″)][I+⅓χ(\vec{x}″)]⁻¹=[3σ−3\tilde{σ}₀I]⁻¹ (22)

We also remark that the tool response depends on the contrast function in a simple non-linear way. If the background conductivity was chosen constant over the whole trajectory as it is done in conventional methods this approximation was not very useful. However, by taking the background conductivity constant over the moving reduced window domain only, this simple approximation of the secondary field response is very effective in the method.

A further embodiment of the invention is that the elements of the C matrix are obtained in closed form by the following analysis.

The conductivity matrix has to be rotated first over the dipping angle \tilde{β} of the local medium layer and over the angle φ of the local borehole axis (see FIG. 6). The rotation matrix is then given by

$${R}^{″} = ( \begin{matrix}{g}_{1}^{″} & 0 & {g}_{3}^{″} \\ 0 & 1 & 0 \\ - {g}_{3}^{″} & 0 & {g}_{1}^{″}\end{matrix} ) = ( \begin{matrix}cos ( \tilde{β} + φ ) & 0 & sin ( \tilde{β} + φ ) \\ 0 & 1 & 0 \\ - sin ( \tilde{β} + φ ) & 0 & cos ( \tilde{β} + φ )\end{matrix} ) \qquad ( 23 )$$

so that the conductivity matrix becomes

$$σ = {R}^{″} ( \begin{matrix}{\tilde{σ}}_{1} & 0 & 0 \\ 0 & {\tilde{σ}}_{2} & 0 \\ 0 & 0 & {\tilde{σ}}_{3}\end{matrix} ) {R}^{″ T} = ( \begin{matrix}{\tilde{σ}}_{1} {g}_{1}^{″2} + {\tilde{σ}}_{3} {g}_{3}^{″2} & 0 & ( {\tilde{σ}}_{3} - {\tilde{σ}}_{1} ) {g}_{1}^{″} {g}_{3}^{″} \\ 0 & {\tilde{σ}}_{2} & 0 \\ ( {\tilde{σ}}_{3} - {\tilde{σ}}_{1} ) {g}_{1}^{″} {g}_{3}^{″} & 0 & {\tilde{σ}}_{1} {g}_{3}^{″2} + {\tilde{σ}}_{3} {g}_{1}^{″2}\end{matrix} ) \qquad ( 24 )$$

Note again that the tilde above a quantity denotes the interpolated values of the quantity in the points of the reduced window. With this expression for the conductivity matrix, the C matrix can be calculated explicitly from Equation (22). Substituting Equation (24) and use of the property that the rotation matrix of Equation (23) is unitary, the final result is

$$C = ( \begin{matrix}\frac{3 {\tilde{σ}}_{1} - 3 {\tilde{σ}}_{0}}{{\tilde{σ}}_{1} + 2 {\tilde{σ}}_{0}} {g}_{1}^{″2} + \frac{3 {\tilde{σ}}_{3} - 3 {\tilde{σ}}_{0}}{{\tilde{σ}}_{3} + 2 {\tilde{σ}}_{0}} {g}_{3}^{″2} & 0 & ( \frac{3 {\tilde{σ}}_{3} - 3 {\tilde{σ}}_{0}}{{\tilde{σ}}_{3} + 2 {\tilde{σ}}_{0}} - \frac{3 {\tilde{σ}}_{1} - 3 {\tilde{σ}}_{0}}{{\tilde{σ}}_{1} + 2 {\tilde{σ}}_{0}} ) {g}_{1}^{″} {g}_{3}^{″} \\ 0 & \frac{3 {\tilde{σ}}_{2} - 3 {\tilde{σ}}_{0}}{{\tilde{σ}}_{2} + 2 {σ}_{0}^{″}} & 0 \\ ( \frac{3 {\tilde{σ}}_{3} - 3 {\tilde{σ}}_{0}}{{\tilde{σ}}_{3} + 2 {\tilde{σ}}_{0}} - \frac{3 {\tilde{σ}}_{1} - 3 {\tilde{σ}}_{0}}{{\tilde{σ}}_{1} + 2 {\tilde{σ}}_{0}} ) {g}_{1}^{″} {g}_{3}^{″} & 0 & \frac{3 {\tilde{σ}}_{1} - 3 {\tilde{σ}}_{0}}{{\tilde{σ}}_{1} + 2 {\tilde{σ}}_{0}} {g}_{3}^{″2} + \frac{3 {\tilde{σ}}_{3} - 3 {\tilde{σ}}_{0}}{{\tilde{σ}}_{3} + 2 {\tilde{σ}}_{0}} {g}_{1}^{″2}\end{matrix} ) \qquad ( 25 )$$

In each point \vec{x}″=\vec{x}_{i,j,k}″ of the discretized reduced window the values of the matrix C are computed directly from the conductivity tensor. Note that for an isotropic medium we have that \tilde{σ}₁=\tilde{σ}₁=\tilde{σ}₂=\tilde{σ} and the matrix C is a diagonal matrix, viz.

$$C = \frac{3 \tilde{σ} - 3 {\tilde{σ}}_{0}}{\tilde{σ} + 2 {\tilde{σ}}_{0}} I , for the isotropic medium \qquad ( 26 )$$

8. Logging Tool Response in Local System

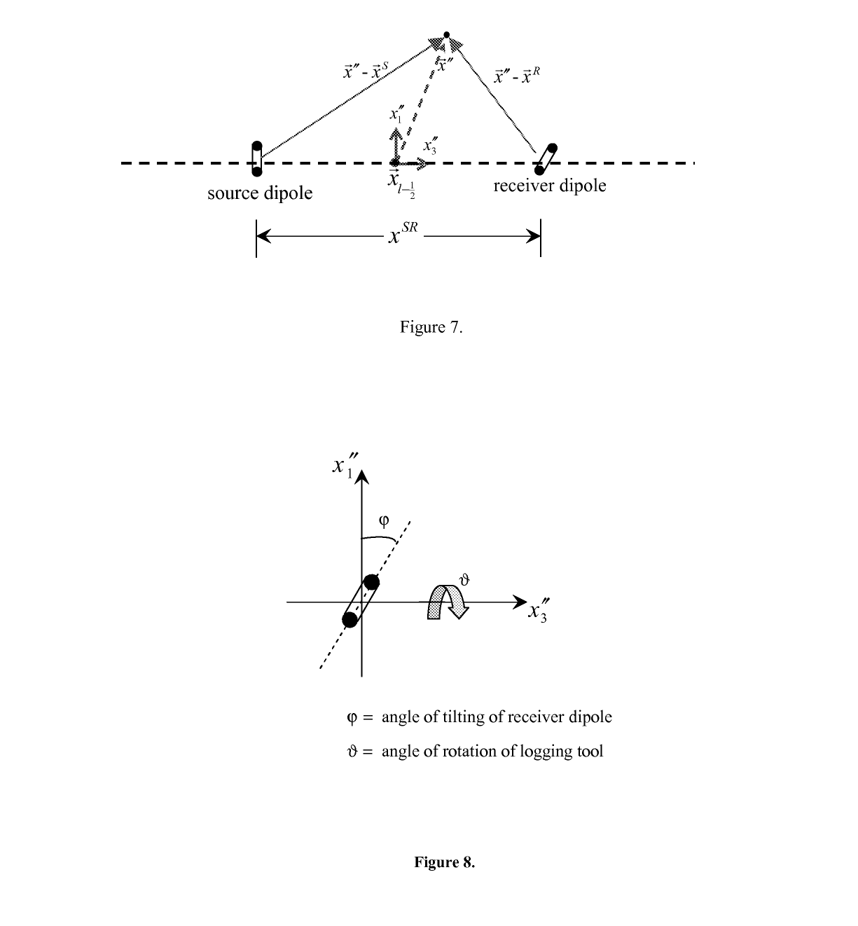

The general steps of the present method for predicting the response of a logging tool with a magnetic source dipole oriented perpendicular to the local borehole axis and a tilted receiver dipole (see FIG. 7 and FIG. 8) are listed below.

For a specific value of the tilting angle φ of the receiver dipole and a specific value of the rotation angle [symbol] of the logging tool the measured magnetic field is obtained as

H=H₁ cos( [symbol] )sin(φ)+H₂ sin( [symbol] )sin(φ)+H₃ cos(φ) (27)

where the magnetic field components consists of a primary contribution {H₁^{prm},H₂^{prm},H₃^{prm}}, being the field present in the background medium with isotropic conductivity \tilde{σ}₀, and a secondary contribution {H₁^{scd}, H₂^{scd},H₃^{scd}}, being the magnetic field generated by the contrasting conductivity with respect to the background conductivity.

For a magnetic source dipole perpendicular to the logging tool axis, the primary field at the borehole axis is given by

$${H}_{1}^{prm} = 0 , {H}_{2}^{prm} = 0 , {H}_{3}^{prm} = {M}^{S} ( \frac{2}{{( {x}^{SR} )}^{2}} + \frac{2 {\tilde{γ}}_{0}}{{x}^{SR}} ) \frac{exp ( - {\tilde{γ}}_{0} {x}^{SR} )}{4 π {x}^{SR}} \qquad ( 28 )$$

The secondary magnetic field components are obtained as

$${H}_{r}^{scd} = - {\tilde{γ}}_{0}^{2} {{M}^{S} ( Δ {x}^{R} )}^{3} {\sum }_{i = - {N}_{1}^{R}}^{{N}_{1}^{R}} {\sum }_{j = - {N}_{2}^{R}}^{{N}_{2}^{R}} {\sum }_{k = - {N}_{3}^{R}}^{{N}_{3}^{R}} {h}_{r , i , j , k} , \\ r = 1 , 2 , 3 \qquad ( 29 )$$

where in each point \vec{x}″=\vec{x}_{i,j,k}″ of the reduced window the values of hᵣ=h_{r,i,j,k} are obtained from

h₁=(−C_{3,1}G_{2,2}+C_{3,2}G_{1,2}+C_{2,1}G_{2,3}−C_{2,2}G_{1,3})

h₂=(−C_{1,1}G_{2,3}+C_{1,2}G_{1,3}+C_{3,1}G_{2,1}+C_{3,2}G_{1,1})

h₃=(−C_{2,1}C_{2,2}+G_{2,2}G_{1,1}+C_{1,1}G_{2,2}−C_{1,2}G_{1,2}) (30)

The values of C_{n,m}, (n,m=1, 2, 3) are the elements of the matrix C=C_{i,j,k} computed, in each point \vec{x}″=\vec{x}_{i,j,k}″ of the reduced window. The matrix G_{s,r} (s=1,2; r=1, 2, 3) is also computed for each point \vec{x}″=\vec{x}_{i,j,k}″ of the reduced window from

$${G}_{s , r} = \frac{\partial G ( {{x}^{->}}^{″} - {{x}^{->}}^{S} )}{\partial {x}_{s}^{″}} \frac{\partial G ( {{x}^{->}}^{″} - {{x}^{->}}^{R} )}{\partial {x}_{r}^{″}} , \\ s = 1 , 2 , \\ r = 1 , 2 , 3 \qquad ( 31 )$$

where \vec{x}″−\vec{x}^{S} is the vector from the center of the location of the source dipole to the point of observation \vec{x}″, while \vec{x}″−\vec{x}^{R} is the vector from the center of the location of the receiver dipole to the point of observation \vec{x}″.

It is important to note the observation that G_{s,r} represents the sensitivity of the contrast point to the tool response. The elements of the sensitivity G_{s,r} can be easily checked by plotting it for all observation points \vec{x}″ in the reduced window. The values of the sensitivity should be relatively negligibly small at the boundaries of the reduced window. If this is not the case the dimensions of the reduced window should be enlarged.

1. A method of predicting the response of an induction logging tool along an arbitrary trajectory in a three-dimensional earth model, wherein the method comprises a confinement of electromagnetic field computations to a limited domain of the geology surrounding the induction logging tool.

2. A method as claimed in claim 1, wherein said arbitrary trajectory is formed from a number of straight line segments.

3. A method as claimed in claim 2, which further comprises using a Cartesian coordinate system, and rotating the coordinate system for each straight line segment so that one of the axes of the coordinate system coincides with each said straight line segment.

4. A method as claimed in claim 3, wherein said coordinate system is repositioned for each straight line segment so that the centre of the coordinate system coincides with the centre of each said straight line segment.

5. A method as claimed in claim 2, wherein said limited domain is a restricted rectangular 3D domain.

6. A method as claimed in claim 2, wherein said limited domain is centered around the centre of each straight line segment.

7. A method as claimed in claim 1, wherein said limited domain is formed from discrete cells.

8. A method as claimed in claim 7, wherein the size of said discrete cells is determined, at least in part, by the frequency of operation of said induction logging tool.

9. A method as claimed in claim 7, wherein the size of said discrete cells is determined, at least in part, by the local conductivity of the material within said restricted domain.

10. A method as claimed in claim 1, wherein the size of said limited domain is determined, at least in part, by the frequency of operation of said induction logging tool.

11. A method as claimed in claim 1, wherein the size of said limited domain is determined, at least in part, by the local conductivity of the material within said limited domain.

12. A method as claimed in claim 1, which further comprises considering the magnetic field at a receiver coil of the induction logging tool to be a superposition of a primary and a secondary constituent, wherein the primary constituent is due to a homogeneous and isotropic background medium having an effective background conductivity which is assumed to be constant throughout said limited domain, and wherein the said effective background conductivity is the average value of the conductivity around the tool domain.

13. A method as claimed in claim 12, wherein said effective background conductivity of said homogeneous and isotropic background medium around the induction logging tool is determined from the responses measured by two closely located axial receiver coils.

14. A method as claimed in claim 12, wherein said effective background conductivity of said homogeneous and isotropic background medium around the induction tool is determined from two responses measured by a single axial receiver coil and generated by two closely located source coils.

15. A method as claimed in claim 12, wherein for the computation of the secondary constituent the single-spherical-scatterer approximation is used.

16. A method as claimed in claim 12, wherein the electromagnetic sensitivity of a medium point in said limited domain is determined with respect to source and receiver coils.

17. A method as claimed in claim 16, where the size of the limited domain is determined by a sensitivity function for said electromagnetic sensitivity.

18. A method as claimed in claim 3, wherein said limited domain is a restricted rectangular 3D domain.

19. A method as claimed in claim 4, wherein said limited domain is a restricted rectangular 3D domain.

20. A method as claimed in claim 3, wherein said limited domain is centered around the centre of each straight line segment.
